(19) United States
(12) Patent Application Publication
(10) Pub. No.: US 2014/0239143 A1
(43) Pub. Date: Aug. 28, 2014

(54) Mounting Bracket for a Mirror

(71) Applicant: Jose D. Hernandez, Miami, FL (US)

(72) Inventor: Jose D. Hernandez, Miami, FL (US)

(21) Appl. No.: 13/773,782

(22) Filed: Feb. 22, 2013

(51) Int. Cl. B60R 1/06

(52) U.S. Cl. CPC B60R 1/06
USPC 248/475.1

(57) ABSTRACT

A mounting bracket is disclosed for mounting a mirror on the passenger side of a vehicle in a manner such that the driver of the vehicle will be able to directly view the mirror through the front windshield of the vehicle as opposed to the passenger window of the vehicle and accordingly view the space on the side of the vehicle. The mounting bracket supports the mirror and is secured to the right front fascia of the vehicle. An additional side connector connects the bracket portion near the mirror to the pillar of the right side of the vehicle. The pillar is intermediate the front windshield and the passenger side window. Additionally, the mounting bracket may be adapted to vehicles which have their steering wheel on the right side and the mounting bracket may be used on the driver side for the driver to view the side view mirror through the windshield.

### BACKGROUND OF THE INVENTION

Most cars and trucks have the passenger side rear view mirror mounted directly on the passenger door. On certain types of vehicles, such as, but not limited to the Chrysler Jeep®, (Chrysler and Jeep are a registered trademarks of the Chrysler Corporation, Detroit Mich.), the doors may be removable completely, or have a clear plastic element zippered thereto. Certain classes of vehicles, mostly classified as off-road or expeditionary, such as the Land Rover® or Range Rover® (Land Rover and Range Rover are registered trademarks of LandRover located in the United Kingdom) may also have a removable passenger side door. Japanese or Korean made vehicles may also have a removable side door capability. Certain military vehicles, such as the American/NATO Humvee, (Humvee is a registered trademark of AM General located in Indianna) as well as Russian/Eastern Block or Chinese Communist military vehicles may also have a passenger door removal capability. As such the passenger side view mirror cannot be mounted to a non-existing door, and a plastic door cannot take the weight of such a rear view mirror. Therefore, a need exists for a mirror mounting bracket which is not attached to the passenger side door to permit the mounting of a passenger side view mirror to permit the driver to see what is behind and aside the vehicle to the right. The embodiment shown and described herein is intended for the line of Chrysler® Jeeps®.

It has also been considered that some nations such as the United Kingdom have the steering wheel on the right side of the vehicle as opposed to the left side of the vehicle as in the United States. In this case the passenger side would be on the left as opposed to the right. The mounting bracket of the invention can easily be adapted to be mounted on the left side of the vehicle. Thus the present invention would apply for left-hand drive vehicles as generally described herein as well as right-hand drive vehicles.

The mounting bracket may be employed with any other vehicle where the passenger door could be removed. This includes, but is not limited to the Jeep® family of vehicles. Further there may exist other circumstances where it would be desirable to place the mirror in such a position achieved through the use of the mounting bracket.

### BRIEF SUMMARY OF THE INVENTION

The invention solves the above problems by providing a passenger side mirror mounting bracket which permits the driver of the vehicle to be able to view the mirror through the front windshield of the vehicle as opposed to the passenger window of the vehicle. The mounting bracket includes three basic portions. The first portion of the mounting bracket is generally rectangular and has the mirror attached to the distal portion of the first portion of the bracket. A second portion of the mounting bracket is angled and is secured to the right front fascia of the vehicle and to the proximal side of the first portion of the mounting bracket. A third portion of the mounting bracket is attached on it's first side to the passenger side pillar which is intermediate the passenger side door and the front windshield. The second side of the third portion of the bracket is also attached to the right side of the first portion of the mounting bracket. The attachments of each of the portions of the mounting bracket may include, but is not limited to, mechanical fasteners. The mounting bracket may be easily retrofit on appropriate vehicles and allows the driver to observe behind and aside the right side of the vehicle whilst looking through the front windshield of the vehicle.

In the United Kingdom vehicles which have the steering wheel on the right and the passenger side on the left. In this case the mounting bracket would be mounted identically as above with the exception that the second portion of the mounting bracket is secured to the left front fascia of the vehicle. Additionally, the second side of the third portion of the bracket would be attached to the left side of the first portion of the mounting bracket.

### BRIEF DESCRIPTION OF THE DRAWINGS

FIG. 1 shows a perspective view of a portion of the vehicle including a portion of the passenger door, the front pillar, the front windshield and the hood; and the mounting bracket with the passenger side mirror attached thereto.

FIG. 2 shows an exploded view of the mounting bracket for the passenger side mirror and the passenger side mirror.

FIG. 3 shows a partial side view of a first portion, partially in section view, of the mounting bracket with the passenger side mirror attached thereto.

FIG. 4 shows a top view of the first portion of the mounting bracket designed to receive the passenger side mirror thereon.

FIG. 5 shows a side view of the first portion of the mounting bracket.

FIG. 6 shows a top view of a second portion of the mounting bracket designed to connect the first portion of the mounting bracket to the right front fascia of the vehicle.

FIG. 7 shows a side view of the second portion of the mounting bracket designed to connect the first portion of the mounting bracket to the front fascia of the vehicle.

FIG. 8 shows an end view of the second portion of the mounting bracket designed to connect the first portion of the mounting bracket to the front fascia of the vehicle.

FIG. 9 shows a side view of one of many possible passenger side view mirrors which may be employed with the mounting bracket for such a passenger side mirror.

FIG. 10 shows a bottom view of one of many possible passenger side view mirrors which may be employed with the mounting bracket for such a passenger side mirror.

FIG. 11 shows front view of one of many possible passenger side view mirrors which may be employed with the mounting bracket for such a passenger side mirror.

FIG. 12 is a partial cutaway view of an embodiment of the mounting bracket including a light mounted thereon.

FIG. 13. is an alternate embodiment of the bracket of the present invention for supporting a mirror on the driver side of the vehicle showing in a perspective view a portion of the vehicle including a portion of the driver door, the front pillar, the front windshield and the hood; and the mounting bracket with the side view mirror attached thereto.

The features of the invention will be best understood from the following description when read in connection with the following drawing figures.

### DETAILED DESCRIPTION OF THE PREFERRED EMBODIMENT

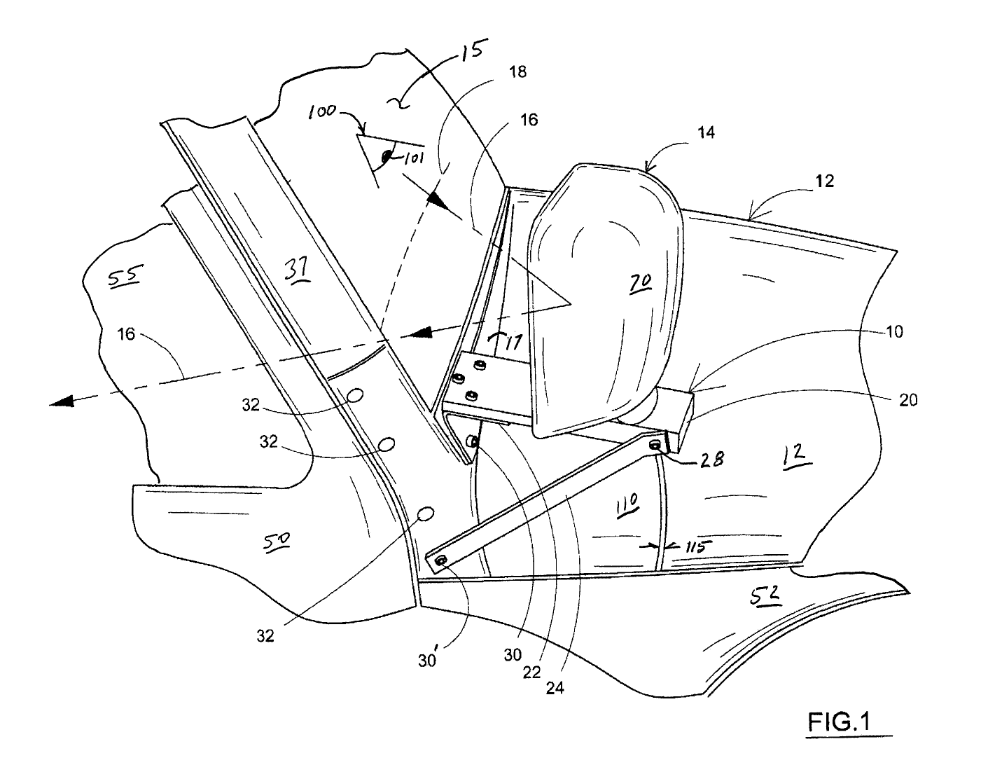

FIG. 1, shows a perspective view of the mounting bracket 10 with the passenger side rear view mirror 14 attached thereto. For the rest of this discussion the passenger side rear view mirror 14 will be referred simply as the mirror 14. For complete accuracy mirror 14 is an assembly which includes a housing 70 holding the mirror, a stem 75 and a tapered post 48. The mirror 14, per se, does not form part of the invention, the invention is directed to the mounting bracket 10 which receives the mirror assembly thereon. The mirror 14 and related elements are shown to more clearly show the apparatus and function of the mounting bracket 10. FIG. 1 also shows the pivotable hood 12, the non-movable rear hood element 110, the gap 115 to allow the hood 12 to open, the passenger door 50, the dashboard 18, the front window 15, the passenger side window 55, a front fender 52 and the passenger side pillar 37. The passenger side pillar 37 is intermediate the front window 15 and the passenger side window 55. The passenger side pillar 37 includes a plurality of tapped holes 32.

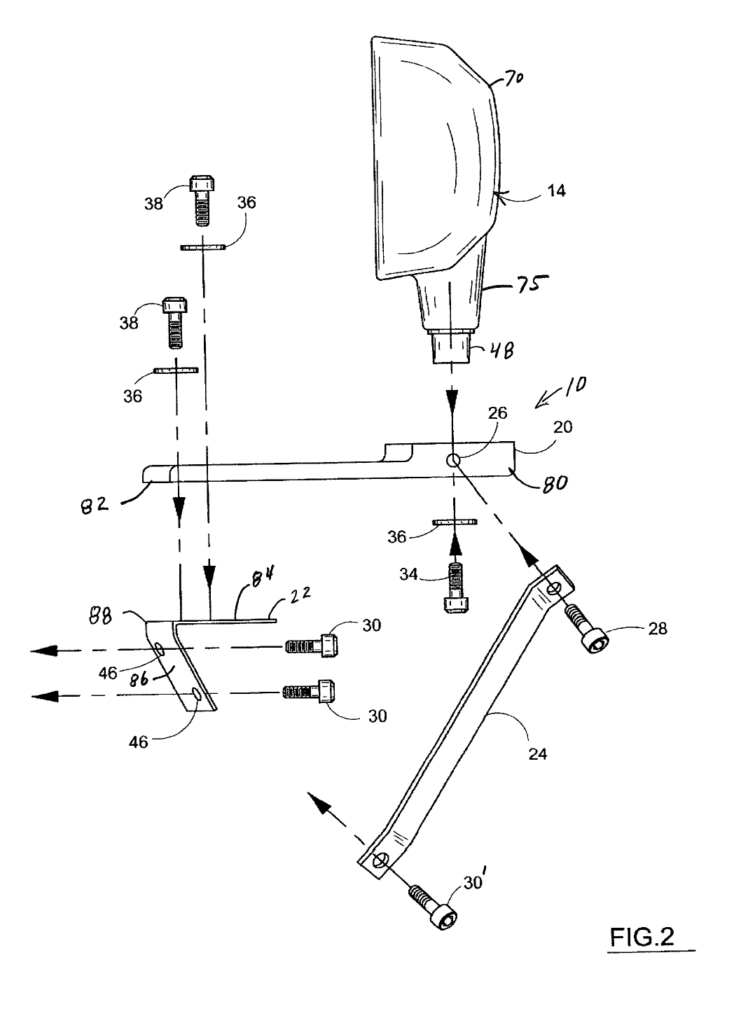

As shown in FIGS. 1 and 2 the mounting bracket 10 includes three major elements. The first element is the main support bracket 20. The second element is an angled bracket connector 22. The third element is a stabilizing bracket 24. By interconnecting the main support bracket 20, the angled bracket 22 and the stabilizing bracket 24 one can see the dashed line of sight 16 from the driver 100 with eye 101 through the front window 15 to the mirror 14. This is how the mounting bracket 10 allows the driver 100 to see what is behind and aside the vehicle on the right side by not looking through the passenger side window 55.

FIG. 2 shows an exploded view of the mounting bracket 10 and the relationship of the main support bracket 20, the angled bracket connector 22 and the stabilizing bracket 24 to the fasteners which connect each bracket portion to one another.

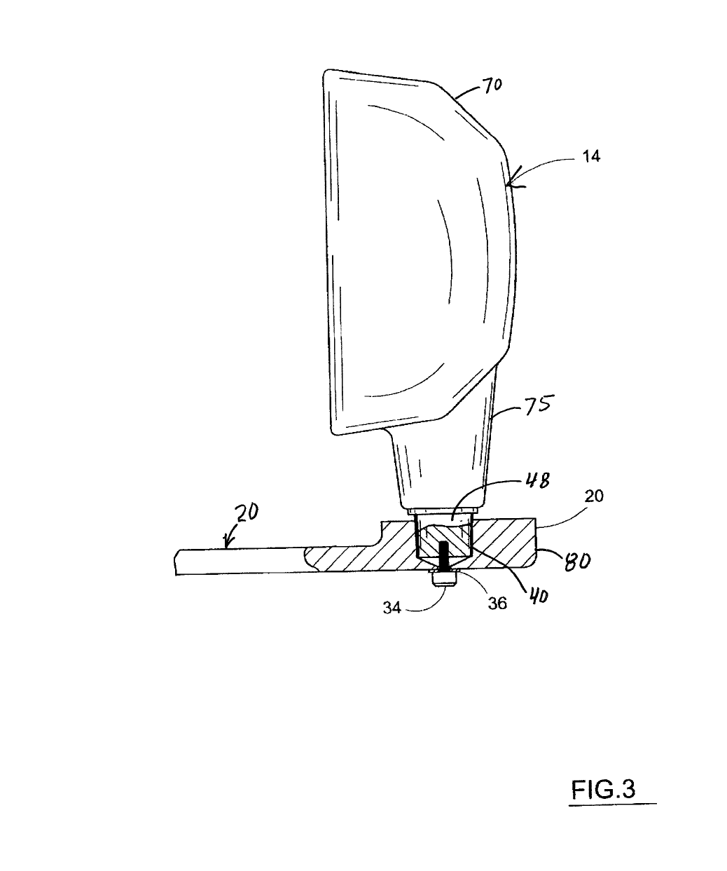

The main support bracket 20 has a distal end 80 and a proximal end 82. The distal end 82 includes a vertical aperture 40 and a horizontal aperture 26. The vertical aperture 40 and the fastener 34 and washer 36 are described in FIG. 3.

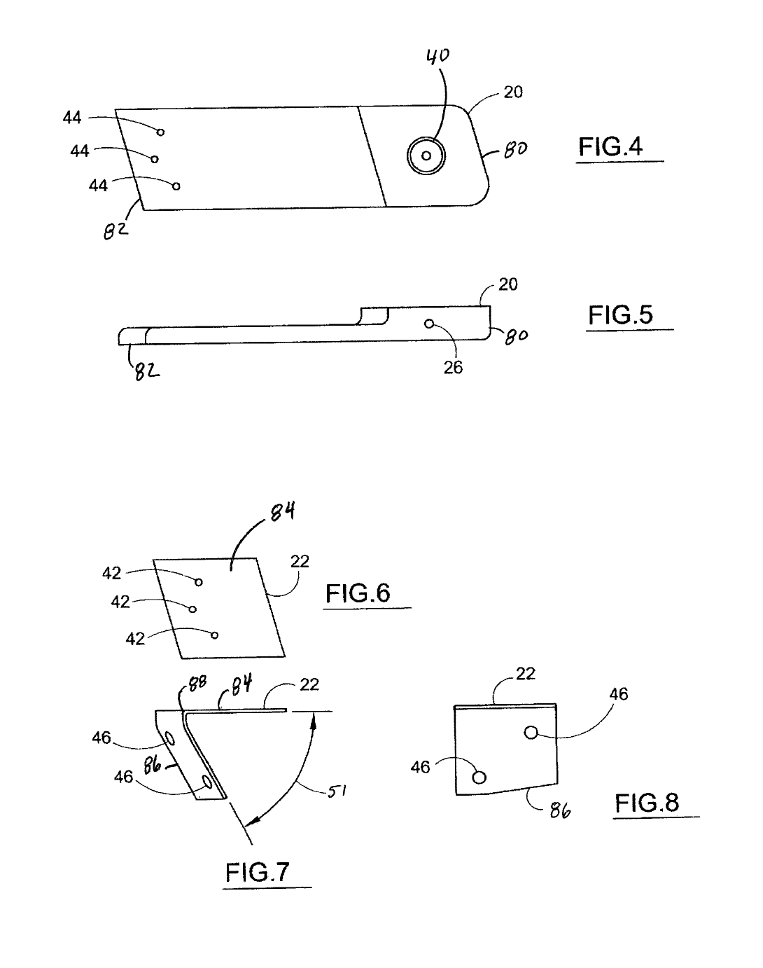

The main support bracket 20 at proximal end 80, has a plurality of apertures 44 (best seen in FIG. 4).

The angled bracket connector 22 has a first side 84 and a second side 86. The first side 84 and the second side 86 are generally about the same length and are bent at point 88 causing an angular separation 50. The angular separation 51 may be between 20 and 70 degrees. The angular separation 51 shown here is about 45 degrees. On the first side 84 are a plurality of apertures 42 (best seen in FIG. 6). The number of apertures on the main support bracket 20 distal end 80 are equal and are in alignment with the plurality of apertures 42 on the first side 84 of the angled bracket connector 22. As shown in FIG. 4 and FIG. 6. There are three apertures on both the main support bracket 20 and the angled bracket connector 22. Returning to FIG. 2, 3 bolts 38 and 3 washers 36 secure the proximal end 82 of the main support bracket 20 to the first side 84 of the angled bracket connector 22. In FIG. 2 only 2 bolts 38 and 3 washers 36 are visible, the third bolt 38 and third washer 36 is obscured by being directly in line with one of the other fastener combinations.

On the second side 86 of the angled bracket connector 22 are a pair of apertures 46. A pair of bolts 30 secure the angled bracket connector 22 and the attached main support bracket bracket 20 to the right front fascia 17 of the vehicle.

The stabilizing bracket 24 is connected to the passenger side pillar 37 by bolt 30′. The stabilizing bracket 24 is further connected to the main support bracket 20 horizontal aperture 26 by bolt 28.

FIG. 3 shows a partial side view in section of a first portion 20 of the mounting bracket 10 with the passenger side mirror 14 attached thereto. A mechanical fastener 34 and washer 36 are shown attached to the tapered post 48 which is received in the vertical aperture 40 on the distal end 80 of the main support bracket 20.

FIGS. 4 and 5 focus on the main support bracket 20. The main support bracket has a distal end 80 and a proximal end 82. The distal end 80 of the main support bracket 20 is designed to receive the mirror 14. The distal end 80 is thicker than the proximal end 82, and includes an aperture 40 to allow the mirror 14 to be interfit and then secured by fastener 34 coming upwards through aperture 40. The proximal end 82 includes a plurality of apertures 44 (best seen in FIG. 4). The number of apertures 44 may be chosen to be three. The length of the main support bracket 20 is such that it does not interfere with the opening of the hood 12.

FIGS. 6 to 8 focus on the angled bracket connector 22. The angled bracket connector 22 has a first side 84 and a second side 86. The angled bracket connector 22 is bent at point 88 forming an angle 51 (best shown in FIG. 7) which is in the range of 20 to 70 degrees and may be chosen to be somewhere about 45 degrees.

The first side 84 of the angled bracket connector 22 includes a plurality of apertures 42. The number of apertures 42 on the first side 84 of the angled bracket connector 22 is chosen to be the same as the plurality of apertures 44 on the proximal end 82 of the main support bracket 20.

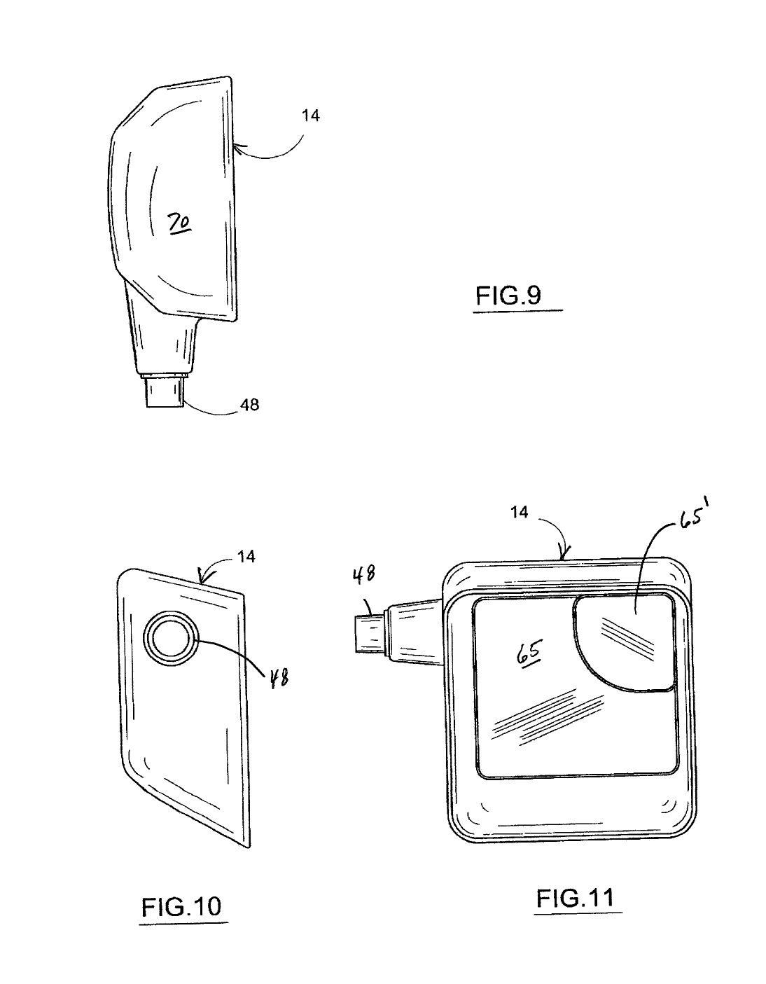

FIGS. 9 to 11 show an embodiment of a mirror 14 which may be adapted to be employed with the mounting bracket 10. FIG. 9 shows a side view mirror 14 with a tapered post 48 designed to interfit into tapered bore 40 (best seen in FIG. 4) and secured therein by nut 34 (best seen in FIG. 2). FIG. 10 shows the bottom view of the mirror 14. Aperture 40 is provided to receive the nut 34 therein after it passes through aperture 40 attaching the mirror 14 to the main support bracket 20. Although not shown it has been contemplated that the mirror 14 may include warming elements to prevent frost of moisture build-up. In addition, mirror 14 may include a small motor or other system to allow it to be adjusted from the interior of the vehicle allowing the mirror 14 to move to the right, left or up and down. FIG. 11 is a front view of the mirror 14, what driver 100 would view and see the side of the vehicle through mirror portion 65 and a magnified portion 65′ of what is to the rear right side of the vehicle.

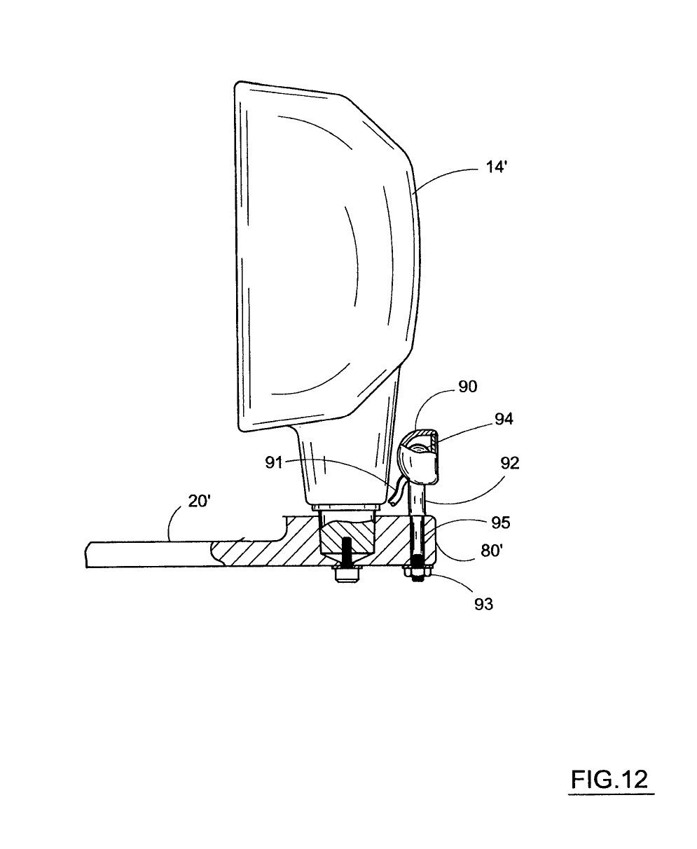

FIG. 12 is a partial cutaway view of an embodiment of the mounting bracket 10 including an accessory element such as a light assembly 90 mounted thereon. The light assembly 90 would be powered by the vehicle through a pair of electrical wires 91. An additional aperture 95 would be located at the distal end 80′ of the main support bracket 20′. A nut 93 would secure the light assembly 90. The light assembly 90 may include a stem 92 and includes a bulb 94. The light assembly 90 may be rotatable. The light assembly 90 may also be combined with a mirror 14′ as previously described. Other accessory elements may be mounted on the main support bracket 20′ in combination with assembly 90 or separately, such as an antenna (not shown) to permit one or two way radio or other band communication.

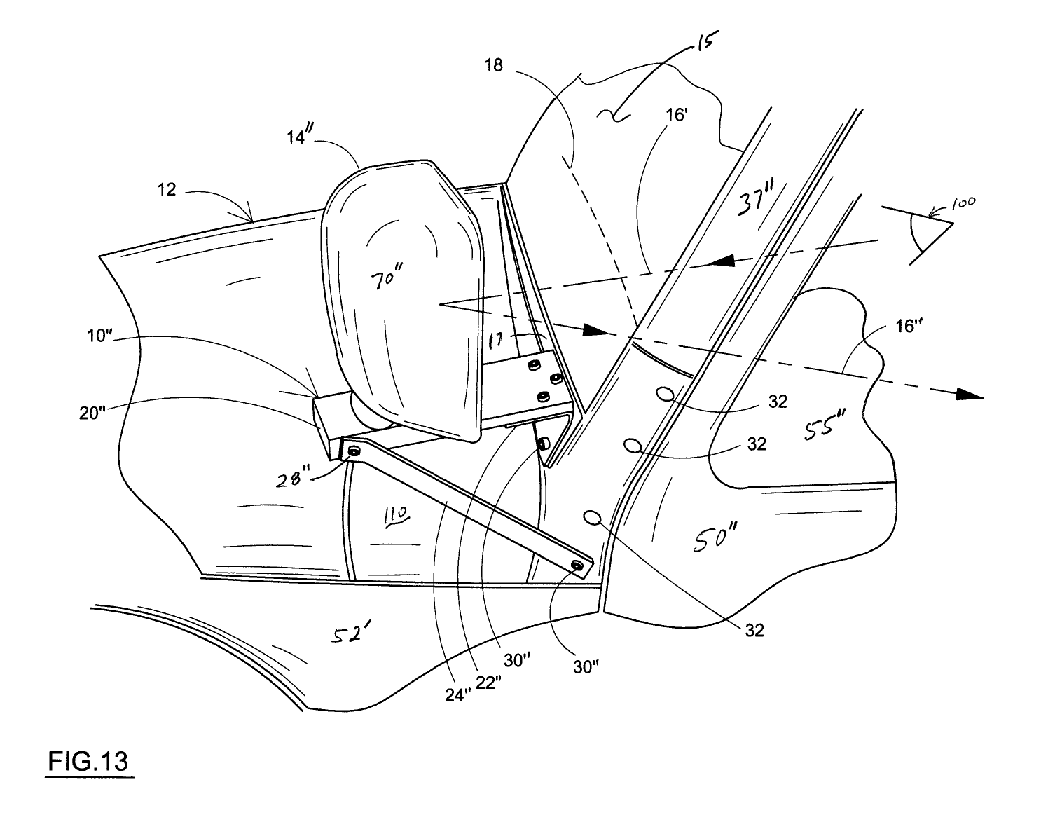

In an alternate mounting arrangement, as seen in FIG. 13, the mounting bracket 10″ is mounted for the driver to view the driver's side view mirror 14″ through the windshield 15. For example, when the driver's door 50″ is removed, the driver's side view mirror 14″ can be viewed through the windshield 15 or alternatively it may be desirable to locate the driver's side view mirror 14″ to be seen through the windshield 15. In this alternate embodiment, the main support bracket 20″ would be mounted on bracket connector 22″ and connector 22″ would be attached to the fascia 17 of the vehicle in front of the driver 100 so the driver's line of site 16″ is through the windshield 15 to mirror 14″ and to the driver's side of the vehicle as shown in FIG. 13. Connector 22″ is connected to fascia 17 with bolts 30″. Likewise stabilizing bracket 24″ provides a support between bracket 20″ and pillar 37″ and is connected to same with bolt 30″. Parts designated and shown in FIG. 13 with a double prime (″) indication are the same or similar to similar parts in FIG. 1, but the double prime indicates the part is for the driver's side of the vehicle. It is further contemplated that a vehicle can have two mirrors of the present invention mounted on separate brackets on the fascia 17 of the vehicle in order that the driver 100 can be able to view and see both mirrors 14 and 14″ as shown individually in FIG. 1 and FIG. 13 through the windshield 15.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A bracket mounted on the front fascia and the pillar of the passenger side of a vehicle, said bracket for attaching the passenger side mirror thereon in which the driver of the vehicle would look through the windshield to view the mirror, said bracket comprising:
a main mirror support bracket portion including a distal end and a proximal end, said distal end further including an outer side and an upper side,
an angled bracket portion including a first side and a second side,
a stabilizing bracket portion including a back side and a front side,
said proximal end attached to said first side,
said second side attached to the front fascia,
said back side attached to the pillar, and
said front side attached to said outer side, whereby
the passenger side mirror is attached to said upper side of said distal end.

2. A bracket mounted on the front fascia and the pillar of the passenger side of a vehicle, said bracket for attaching the passenger side mirror thereon in which the driver of the vehicle would look through the windshield to view the mirror as claimed in claim 1 wherein said distal end further has a light affixed thereto.

3. A bracket mounted on the front fascia and the pillar of the passenger side of a vehicle, said bracket for attaching the passenger side mirror thereon in which the driver of the vehicle would look through the windshield to view the mirror as claimed in claim 1 wherein said distal end further has an antenna affixed thereto.

4. A bracket mounted on the front fascia and the pillar of the passenger side of a vehicle, said bracket for attaching the passenger side mirror thereon in which the driver of the vehicle would look through the windshield to view the mirror as claimed in claim 1 wherein said distal end further has an antenna and a light affixed thereto.

5. A bracket mounted on the front fascia of the passenger side of a vehicle, said bracket for attaching the passenger side mirror thereon in which the driver of the vehicle would look through the windshield to view the mirror, said bracket comprising,
a main mirror support bracket portion including a distal end and a proximal end, said distal end including an upper side,
an angled bracket portion including a first side and a second side,
said proximal end attached to said first side,
said second side attached to the front fascia,
whereby the passenger side mirror is attached to said upper side of said distal end.

6. A bracket mounted on the front fascia of the passenger side of a vehicle as claimed in claim 5, wherein the bracket is further mounted on the pillar of the passenger side of a vehicle, whereby said distal end further includes an outer side,
said bracket further includes a stabilizing bracket portion including a back side and a front side,
where said back side is attached to the pillar, and
said front side is attached to said outer side, further stabilizing said said main mirror support bracket.

7. A bracket mounted on the front fascia and the pillar of the passenger side of a vehicle, said bracket for attaching the passenger side mirror thereon in which the driver of the vehicle would look through the windshield to view the mirror as claimed in claim 6 wherein said distal end further has a light affixed thereto.

8. A bracket mounted on the front fascia and the pillar of the passenger side of a vehicle, said bracket for attaching the passenger side mirror thereon in which the driver of the vehicle would look through the windshield to view the mirror as claimed in claim 6 wherein said distal end further has an antenna affixed thereto.

9. A bracket mounted on the front fascia and the pillar of the passenger side of a vehicle, said bracket for attaching the passenger side mirror thereon in which the driver of the vehicle would look through the windshield to view the mirror as claimed in claim 6 wherein said distal end further has an antenna and a light affixed thereto.

10. A bracket mounted on the front fascia of the passenger side of a vehicle, said bracket for attaching the passenger side mirror thereon in which the driver of the vehicle would look through the windshield to view the mirror, said bracket comprising,
a main mirror support bracket portion including a distal end and a proximal end, said distal end including an upper side,
an angled bracket portion including a first side and a second side,
said proximal end attached to said first side,
said second side attached to the front fascia,
whereby the passenger side mirror is attached to said upper side of said distal end.

11. A bracket mounted on the front fascia of a vehicle, said bracket for attaching a side view mirror thereon in which the driver of the vehicle views said mirror through the windshield of the vehicle to view the reflection contained in the mirror, said bracket comprising,
a main mirror support bracket portion including a distal end and a proximal end, said distal end including an upper side,
an angled bracket portion including a first side and a second side,
said proximal end attached to said first side,
said second side attached to the front fascia of the vehicle,
whereby said mirror is attached to said upper side of said distal end of said support bracket.

12. A bracket mounted on the front fascia of a vehicle as in claim 11, said vehicle having a windshield pillar, whereby said bracket is further supported on said vehicle by a stabilizing bracket connected at one end to said bracket and at the other end to said windshield pillar.

13. A bracket mounted on the front fascia of a vehicle as in claim 12, wherein said distal end further has an accessory element affixed thereto.

14. A bracket mounted on the front fascia of a vehicle as in claim 12, and further having a second bracket mounted on the front fascia of the vehicle supporting a second mirror attached to the windshield pillar on the side of the vehicle opposite the driver side whereby the driver can view both mirrors through the windshield and whereby said first mirror provides a view of the driver side of the vehicle and said second mirror provides a view of the opposite side of said vehicle.
